(19) United States
(12) Patent Application Publication
(10) Pub. No.: US 2004/0027746 A1
(43) Pub. Date: Feb. 12, 2004

(54) Electrical contact system

(76) Inventors: Geert Devooght, Koekelare (BE); Willy Marrecau, Rome (BE); Koen Wastijn, Deerlijk (BE)

Correspondence Address: FOLEY AND LARDNER, SUITE 500, 3000 K STREET NW, WASHINGTON, DC, 20007, US

(21) Appl. No.: 10/416,295

(22) PCT Filed: Nov. 7, 2001
(86) PCT No.: PCT/EP01/13049

(51) Int. Cl. H02H 9/00

(52) U.S. Cl. 361/58

(57) ABSTRACT

An electrical contact system (11) comprising an electrically conductive porous fleece (12) and one or more electrical contacts (13) is provided. The electrical contacts (13) are applied on the electrically conductive porous fleece (12) by means of a coating technique.

### FIELD OF THE INVENTION

The present invention relates to an electrical contact system and more particularly to an electrically conductive filter element comprising such electrical contact system.

### BACKGROUND OF THE INVENTION

Electrically conductive filter elements are known, e.g. from EP 764 455. A filter element, comprising metal fibers, is used to filter soot particles. To regenerate the filter element, an electric current is applied. The filter is heated by the Joule effect.

At present, the electric current is supplied to the filter fleece via electrical contacts, which are welded to the fleece, or which may be clamped to the fleece.

In spite of all care, the contact surface between the welded electrical contact and the fleece has some disadvantages. Due to the high current during regeneration, the fleece may be damaged e.g. burned locally.

When current passes from the electrical contact to the fleece, the current tends to follow preferential routes. The current flows preferentially from the electrical contact into the fleece at the places, where, due to uneven welding, the contact between the electrical contact and the fleece is the most intimate.

The same happens when an electrical contact and a fleece are clamped to each other.

These preferential routes cause so called “hot spots” on the fleece surface. These spots tend to heat up more than the other parts of the fleece surface, since more current flows locally, and the temperature is increased locally extensively due to the Joule effect. At these hot spots, the fiber fleece will oxidize more, causing locally a quick degeneration of the fleece. This finally results in a burning through of the transition zone between the fleece and the electrical contact.

This problem occurs not only for electrically regenerating filters, but also in all cases where an electrical contact (having a low electrical resistance) contacts an electrically conductive porous fleece (having a high electrical resistance).

### SUMMARY OF THE INVENTION

It is an object of the present invention to provide an electrical contact system, which does not have the drawbacks of the prior art.

It is another object of the invention to provide an efficient method of manufacturing an electrical contact system that allows it to make the electrical contact system at low cost.

It is a further object to use the electrical contact system of the present invention to provide a filter element.

According to a first aspect of the present invention, an electrical contact system is provided. The electrical contact system comprises an electrically conductive porous fleece and at least one electrical contact. The porous fleece has an upper and a lower surface. The electrical contact or contacts is/are applied on one of the upper or lower surface or on both surfaces by means of a coating technique.

Possibly, the electrical contact system further comprises one or more electrically isolating portions. The electrically isolating portions cover at least partially the upper and/or lower surface of the porous fleece. Preferably, the electrically isolating layers are applied by means of a spraying operation.

With electrically conductive porous fleece is meant a fleece comprising electrically conductive fibers and/or particles. The electrically conductive porous fleece comprises for example metal fibers and/or metal particles, such as metal powder. In a preferred embodiment the electrically conductive porous fleece comprises a non-woven metal fiber web.

Preferred metal fibers are steel fibers with a high specific electrical resistance. Suitable stainless steel fibers are fibers from AISI 300- or AISI 400-serie alloys such as AISI 316L or AISI347, or alloys comprising Fe, Al and Cr, such as Fecralloy®.

Preferably, stainless steel fibers comprising chromium, aluminium and/or nickel and 0.05 to 0.3% by weight of yttrium, cerium, lanthanum, hafnium or titanium are used.

The fiber diameter is preferably between 1 and 100 μm, e.g. between 12 and 35 μm.

The metal fibers can for example be obtained by bundle drawing or by shaving techniques (e.g. as described in U.S. Pat. No. 4,930,199), or by any other process as known in the art.

Possibly, the porous fleece is sintered before the electrical contacts are applied.

With electrical contact is meant an object which is connected to an electric circuit, e.g. via a lead wire, and which is connected to the electrically conductive porous fleece via a contact surface in order to provide the electric current from the electric circuit to this electrically conductive porous fleece.

According to the present invention, the electrical contacts are applied on the electrically conductive porous fleece by a coating technique.

The electrical contacts are applied on at least a limited surface of the electrically conductive porous fleece, either at its upper surface, its lower surface or at both surfaces.

The electrical contact comprises a metal or metal alloy, such as a nickel or nickel alloy.

Preferred nickel alloys comprise between 27 and 34% Cu. These alloys are known as Monel®. Possibly, the nickel alloy further comprises other elements such as manganese, iron, aluminium, silicium, titanium, sulfur and/or carbon. A suitable alloy is Monel K-500, comprising 63% Ni, between 27 and 33% Cu, between 2.30 and 3.20% Al, between 0.35 and 0.85% Ti, up to 0.25% C, up to 2% Fe, up to 1.50% Mn, up to 0.010% Sand up to 0.50% Si.

Any coating technique that result in applying a coating layer according to this invention can thereby be considered.

Such techniques are for example spraying, vapour deposition, such as chemical vapour deposition or plating such as chemical plating, melt plating and electroplating.

A preferred technique is thermal spraying. The electrical contact can for example be flame sprayed or it can be sprayed by using an electric arc or plasma gun.

The thickness of the electrical contact is preferably between 0.01 and 3 mm, more preferably the thickness is between 0.05 and 1 mm. The thickness of the electrical contact can be constant over its whole surface. Alternatively, the thickness can vary gradually, for example from zero at a certain distance from the edge towards its maximum thickness at the edge. This gradually increasing thickness ensures that there is a smooth transition from the high conductive coating to the low conductive filter.

It was found that, when an electrical contact is applied to the electrically conductive porous fleece by means of a coating technique, such as spraying or plating, a very intimate and equal contact between the electrical contact and the electrically conductive porous fleece is obtained over their total contact surface.

This intimate and equal contact is due to the fact that there is not only contact between the metal or metal alloy of the sprayed electrical contact and the fibers located at the outer surface of the electrically conductive porous fleece but also between the metal or metal alloy of the electrical contact and the fibers of the fleece located more internally.

The contact between the sprayed electrical contact and the electrically conductive porous fleece is more intimate compared with an electrical contact system whereby the electrical contact is welded to the electrically conductive porous fleece and is even more intimate compared with an electrical contact system whereby the electrical contact is sintered to the fleece.

Because of the intimate and equal contact, the electric current which has to flow from the electrical contact to the electrically conductive porous fleece will have the same resistance on every spot of the contact surface between the electrical contact and the electrically conductive porous fleece.

No hot spots are noticed during the supply of electric current to the electrically conductive porous fleece via the electrical contact.

The electric current, provided to a first electrical contact by an electrical circuit, will flow from this contact, into the electrically conductive porous fleece via the contact surface between the electrical contact and the electrically conductive porous fleece.

The electric current further flows through the electrically conductive porous fleece towards a second electrical contact, also making contact to the electrically conductive porous fleece via a contact surface. It is clear that, in the scope of the invention, the electric current flowing through the electrically conductive porous fleece effects the heating of the filter element.

In an electrical contact system as subject of the invention, the electric current does not flow from the electrical contact into the electrically conductive porous fleece via preferential routes. The change from low electrical resistance (electrical contact) to higher electric resistance (electrically conductive porous fleece) will be very smooth and an equal current distribution over the total volume of the electrically conductive porous fleece is provided. Due to the spraying action, very intensive contact is obtained between the fibers of the electrically conductive porous fleece and the electrical contact. They are so to say micro-welded to each other.

According to the invention, one or more electrical contacts are applied to the electrically conductive porous fleece.

The position of these electrical contacts on the electrically conductive porous fleece may be changed depending on the requirements as specified by the use of the electrical contact system.

Usually, two or more electrical contacts are applied at the border of the electrically conductive porous fleece.

The electrical contacts can be applied on one or on both sides of the electrically conductive porous fleece.

According to a second aspect of the invention, a method of manufacturing an electrical contact system is provided.

The method comprises the steps of

providing an electrically conductive porous fleece;

applying at least one electrical contact on at least one surface of said electrically conductive porous metal fleece by a coating technique.

Preferred coating techniques are spraying or vapour deposition. The electrical contact is preferably applied by spraying, such as thermal spraying. The electrical contact can for example be flame sprayed or it can be sprayed by using an electric arc or plasma gun.

Possibly, the method further comprises the step of:

applying at least one electrically insulating portion on at least on surface of the electrically conductive porous metal fleece.

The method according to the present invention features the advantage over the conventionally used methods of manufacturing electrical contact systems, such as methods whereby an electrical contact is welded or sintered to an electrically conductive porous fleece, that a more intimate contact between the electrical contact and the electrically conductive porous fleece is obtained.

Furthermore, the method according to the present invention can be considered as a very efficient and easy method that in addition allows to manufacture electrical contact systems at low cost.

Electrical contact system as subject of the invention may be used to provide a heating element or a heatable or regeneratable filter, e.g. an exhaust particulate filter, such as a diesel exhaust filter. According to the functionality, required by the application, the electrically conductive porous fleece may have a different porosity, thickness, composition, electrical resistance, dimension or shape.

Also according to the application, the position of the electrical contacts compared to the electrically conductive porous fleece may be chosen.

### BRIEF DESCRIPTION OF THE DRAWINGS

The invention will now be described into more detail with reference to the accompanying drawings wherein

FIG. 1 and FIG. 2 show two embodiments of electrical contact systems as subject of the invention;

FIG. 3 illustrates an embodiment comprising electrical contacts at both sides of the electrically conductive porous fleece;

FIG. 4 shows an undulated electrically conductive porous fleece with electrical contacts applied to it.

### DESCRIPTION OF THE PREFERRED EMBODIMENTS OF THE INVENTION

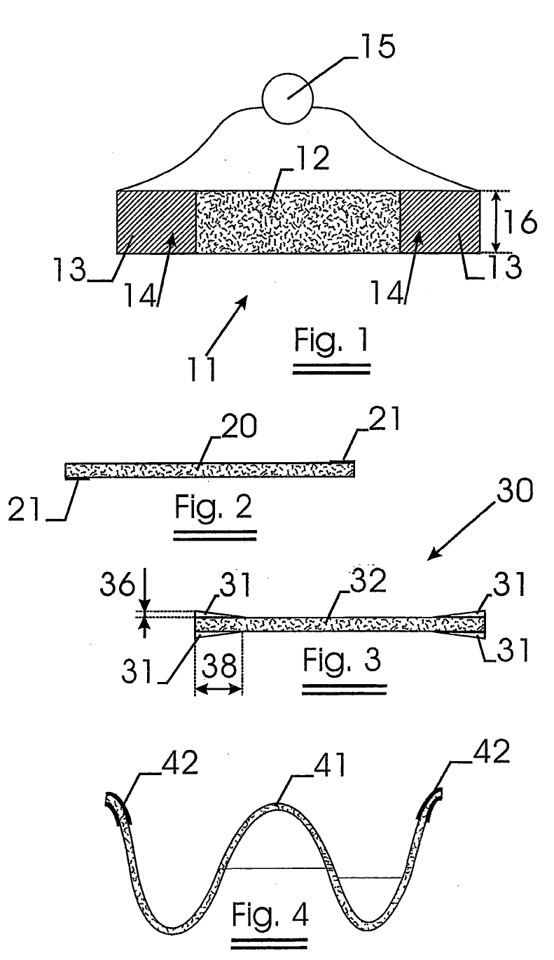

FIG. 1 shows an embodiment of an electrical contact system 11 as subject of the invention.

At one side of an electrically conductive porous fleece 12, two electrical contacts 13 are applied. Each of the electrical contacts is applied at one edge of the electrically conductive porous fleece.

An electrical circuit 15 is connected to both electrical contacts 13. The current runs from the electric circuit 15 via one of the electrical contacts 13, through the first surface 14, via the fibers or powder in the electrically conductive porous fleece 12, again via the second surface 14 and electrical contact 13 to the opposite end of the electric circuit.

A preferred embodiment comprises an electrically conductive porous fleece made of Fecralloy® bundle drawn fibers with fiber diameter of 17 μm on which two electrical contacts are applied by a spraying operation. The electrically conductive porous fleece has a surface weight of approximately 1000 g/m².

Both electrical contacts are located at the same side of the electrically conductive porous fleece.

The electrical contacts are made of a nickel copper alloy and have a thickness of for example 70 μm.

The width 16 of the electrically conductive porous fleece is 33 mm. Preferably, the electrically conductive porous fleece and the electrical contact have the same width.

The contact surfaces 14 are for example square.

Similar embodiments are obtainable using other dimensions.

Alternative embodiments are provided using a porous fleece comprising fibers with other fiber diameters, such as 12 μm, 22 μm or 35 μm, or a combination from different diameters, being bundle drawn or shaved Fecralloy® fibers.

In other embodiments the electrically conductive porous fleece comprises a multilayered structure. A suitable layered structure comprises a first layer of metal fibers with a diameter of 17 μm (weight of the layer 600 g/m²), a second layer of metal fibers with a diameter of 22 μm (250 g/m²) and a third layer of metal fibers having a diameter of 35 μm (600 g/m²).

It is not necessary that all electrical contacts are applied at one side of the electrically conductive porous fleece. As can be seen in FIG. 2, the electrical contacts 21 may be applied on opposite sides of the electrically conductive porous fleece 20.

FIG. 3 shows the cross-section of an alternative embodiment. The electrical contact system 30 comprises electrical contacts 31 on both the upper and the lower side of the electrically conductive porous fleece 32. The electrical contacts are applied on the electrically conductive porous fleece by spraying.

The thickness of the electrical contact decreases gradually from the outer border of the electrically porous fleece.

The thickness 36 of the electrical contact at the outer border of the electrical conductive porous fleece is for example 70 μm. The thickness decreases gradually from the outer border towards zero over a length 38. The length 38 ranges preferably between 25 and 50 mm, and is for example 30 mm.

According to the use of the electrical contact system, the electrically conductive porous fleece 41 of the element may be bend for example as shown in FIG. 4.

The embodiment of an electrical contact system as shown in FIG. 4 is preferably used as an electrically conductive filter element, e.g. an electrically regeneratable filter, to filtering diesel exhaust gasses. Gas to be filtered is to flow through the electrically conductive porous fleece. Soot, being trapped by the filter accumulates on the electrically conductive porous fleece surface and/or in the electrically conductive porous fleece. The filter is regenerated by providing electric current from an electric circuit, which is connected to the electrical contacts 42, via these electrical contacts 42 to the electrically conductive porous fleece 41.

1. An electrical contact system comprising an electrically conductive porous fleece and at least one electrical contact, said porous fleece having an upper and a lower surface and said electrical contacts being applied on at least one of said upper or lower surface of said fleece, characterised in that said electrical contacts being applied by a coating technique.

2. An electrical contact system according to claim 1, whereby said electrical contacts are applied by a spraying operation.

3. An electrical contact system according to claim 1, whereby said electrical contacts are applied by vapour deposition.

4. An electrical contact system according to claim 1, whereby said electrical contacts are applied by a plating operation.

5. An electrical contact system according to any one of the preceding claims, whereby said electrical contact system further comprises at least one electrically isolating portion, said electrically isolating portions are applied on at least one of said upper or lower surface of said electrically conductive porous fleece and said electrically isolating layers cover at least partially said upper or lower surfaces.

6. An electrical contact system according to any one of the preceding claims, whereby at least one of said electrical contacts is located at the border of said electrically conductive porous fleece.

7. An electrical contact system according to any one of the preceding claims, whereby said electrically conductive porous fleece comprises metal fibers.

8. An electrical contact system according to any one of the preceding claims, whereby said electrically conductive porous fleece comprises metal powder.

9. An electrical contact system according to claim 7 or 8, whereby said metal is stainless steel.

10. An electrical contact system according to claim 9, whereby said stainless steel comprises chromium, aluminium and/or nickel and 0.05 to 0.3% by weight of yttrium, cerium, lanthanum, hafnium or titanium.

11. An electrical contact system according to any one of the preceding claims whereby said electrically conductive porous fleece is sintered.

12. An electrical contact system according to any one of the preceding claims, whereby said electrical contacts comprise a metal or metal alloy.

13. An electrical contact system according to claim 12, whereby said metal or metal alloy comprises a nickel or nickel alloy.

14. A method of manufacturing an electrical contact system according to claims 1 to 13, comprising the steps of
providing an electrically conductive porous fleece;
applying at least one electrical contact on at least one surface of said electrically conductive porous metal fleece by means of a coating technique.

15. A method according to claim 14, whereby said coating technique comprises a spraying technique a vapour deposition technique or a plating technique.

16. A method according to claims 14 or 15, further comprising the step of
applying at least one electrically insulating portion on at least on surface of the electrically conductive porous metal fleece.

17. Use of an electrical contact system according to any one of claims 1 to 13 to provide a filter element.

18. Use according to claim 17, whereby said filter element can be regenerated electrically.

19. Use according to claim 17 or 18 to provide an exhaust particulate filter element.

20. Use according to any one of claims 17 to 19 to provide a diesel exhaust filter element.

21. Use according to any one of claims 17 to 20 to provide an electrically heatable element.

22. Use according to any one of claims 17 to 21 to provide an electrically heatable filter element.
